(19) United States
(12) Patent Application Publication
(10) Pub. No.: US 2015/0167222 A1
(43) Pub. Date: Jun. 18, 2015

(54) APPARATUS AND METHOD OF CONTROLLING A WASHING MACHINE

(71) Applicant: Dongbu Daewoo Electronics Corporation, Seoul (KR)

(72) Inventors: Hye Min HWANG, Incheon (KR); Joon Gil LEE, Incheon (KR)

(73) Assignee: Dongbu Daewoo Electronics Corporation, Seoul (KR)

(21) Appl. No.: 14/158,192

(22) Filed: Jan. 17, 2014

(30) Foreign Application Priority Data
Dec. 17, 2013 (KR) 10-2013-0157074

(51) Int. Cl. D06F 33/02; G05B 15/02; D06F 58/26; D06F 58/02; D06F 35/00; D06F 29/00

(52) U.S. Cl. CPC D06F 33/02; D06F 35/005; D06F 29/005; D06F 58/26; D06F 58/02; G05B 15/02; D06F 2202/12; D06F 2204/10; D06F 2204/04; D06F 2204/086

(57) ABSTRACT

The present disclosure relates to an apparatus and a method of controlling a washing machine, and the apparatus for controlling the washing machine includes a door detecting sensor configured to detect an open door of the washing machine; a driver configured to drive a drum of the washing machine; and a controller configured to recognize or determine whether the door is open from the door detecting sensor, and drive the driver to rotate the drum when the door is not open for a predetermined time after an end of a washing process of the washing machine. Accordingly, washed clothes left inside the washing machine for a long time after the end of the washing processes are managed, thereby preventing laundry having wrinkles and/or unpleasant smells or odors.

### CROSS-REFERENCE TO RELATED APPLICATIONS

This application is based on and claims priority from Korean Patent Application No. 10-2013-0157074, filed on Dec. 17, 2013, the disclosure of which is incorporated herein in its entirety by reference.

### TECHNICAL FIELD

The present disclosure relates to an apparatus and a method of controlling a washing machine, and more particularly, to an apparatus and a method of controlling a washing machine that prevents damage to washed clothes after the washing process.

### BACKGROUND

In general, a washing machine is an apparatus for cleaning and removing various pollutants in and/or attached to laundry, such as clothes and bedding, by using a detergent emulsion, frictional action of water that flows from rotational motion of a pulsator or other rotating member, impact with the laundry, and the like. Recently emerging automatic washing machines may automatically perform a series of processes or cycles, including washing, rinsing, and drying, without any intermediate manipulation of a user.

Generally, washing machines may be classified into a top-loading type washing machine having a washing tub, and a drum type washing machine having the washing tub that holds or accommodates laundry. Compared to the top loading-type washing machine, the drum type washing machine may (i) have shorter dimensions, (ii) accommodate a larger load of laundry, and (iii) minimize and/or prevent twisting and damaging clothes. Thus, demands thereof have gradually increased.

The general washing machine automatically performs a series of processes including washing, rinsing and drying when a user inserts a detergent, a bleaching agent, fabric softener, and/or the like into a detergent box, selects a type of laundry, a washing time, and the like using a control panel, and presses a start button. When all of the washing processes end, the washing machine generates a sound (e.g., an alarm) notifying the user that the washing process has ended.

However, living spaces have become bigger, and spaces for home appliances may be further away or separated from the main living spaces. Thus, there are many cases in which the washing machine is installed in a separate location.

Accordingly, the washing machine may be installed in a location such as a bathroom, a veranda, or in a garage, so that the user cannot hear the alarm indicating that the washing process has ended.

Accordingly, when the power of the washing machine is turned off after the end of the washing process and/or the user does not remove the laundry from the washing machine for a long time, the laundry may be left inside the washing tub. As a result, the laundry may become wrinkled and/or acquire an unpleasant smell.

A conventional washing machine may be disclosed in Korean Patent Application Publication No. 2010-0047623, filed on May 10, 2010.

### SUMMARY

The present disclosure has been made in an effort to provide an apparatus and a method of controlling a washing machine that prevents damage to laundry by managing washed clothes left inside the washing machine for a predetermined time when a user fails to hear an ending sound or alarm and/or forgets to remove the washed clothes after a washing process has ended.

Technical objects of the present disclosure are not limited to the aforementioned technical objects and other technical objects which are not mentioned will be apparently appreciated by those skilled in the art from the following description.

Exemplary embodiments of the present disclosure provide an apparatus for controlling a washing machine, including a door detecting sensor configured to detect opening of a door of the washing machine; a driver configured to drive a drum of the washing machine; and a controller configured to recognize or determine whether the door is opened from the door detecting sensor, and drive the driver to rotate the drum when the door is not open (e.g., closed) for a predetermined time after an end of the washing.

Other exemplary embodiments of the present disclosure provide an apparatus for controlling a washing machine, including a door detecting sensor configured to detect an open door of the washing machine; at least one fan at an outer periphery of a drum of the washing machine; and a controller configured to recognize or determine whether the door is open from the door detecting sensor, and drive the fan when the door is not open (e.g., closed) for a predetermined time after an end of the washing.

Yet other exemplary embodiments of the present disclosure provide a method of controlling a washing machine, including ending a washing course or process of the washing machine; detecting an open door of the washing machine after the washing course or process ends; standing by or waiting for a predetermined time while the door is not open (e.g., is closed); and preventing damage to or protecting washed clothes in a drum of the washing machine.

According to exemplary embodiments of the present disclosure, when a user fails to hear an ending sound (e.g., alarm), forgets to remove the washed clothes from the washing machine after the washing process(es) or course(s) have ended, or the user leaves the premises, the power of the washing machine does not immediately turn off, and the washed clothes inside the washing machine are managed for a predetermined time through processes such as rotating, rinsing, and drying, thereby preventing wrinkles in the laundry and/or unpleasant smells in the laundry.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a lateral cross-sectional view illustrating an exemplary washing machine to which an apparatus and a method of controlling a washing machine of the present disclosure are applied.

FIG. 2 is a flow chart illustrating an exemplary method of controlling a washing machine according to the present disclosure.

FIG. 3 is a configuration diagram illustrating an apparatus for controlling a washing machine according to exemplary embodiments of the present disclosure.

FIG. 4 is a flow chart illustrating a method of controlling the washing machine according to exemplary embodiments of the present disclosure.

FIG. 5 is a configuration diagram illustrating an apparatus for controlling a washing machine according to one or more further exemplary embodiments of the present disclosure.

FIG. 6 is a flow chart illustrating a method of controlling a washing machine according to other exemplary embodiments of the present disclosure.

### DETAILED DESCRIPTION

Hereinafter, exemplary embodiments according to the present disclosure will be described in detail with reference to the accompanying drawings. In the process, a size or a shape of a constituent element illustrated in the drawings, and the like, may be exaggerated for clarity and ease of description. Terms may be specially defined in consideration of configurations and operations of the present disclosure, and may vary depending on the intention or usual practice of a user or an operator. These terms should be defined based on the content throughout the present specification. The spirit of the present disclosure is not limited to the suggested exemplary embodiments; those skilled in the art who understand the spirit of the present disclosure may easily carry out other exemplary embodiments within the scope of the same spirit, and of course, the other exemplary embodiments also belong to the scope of the present disclosure.

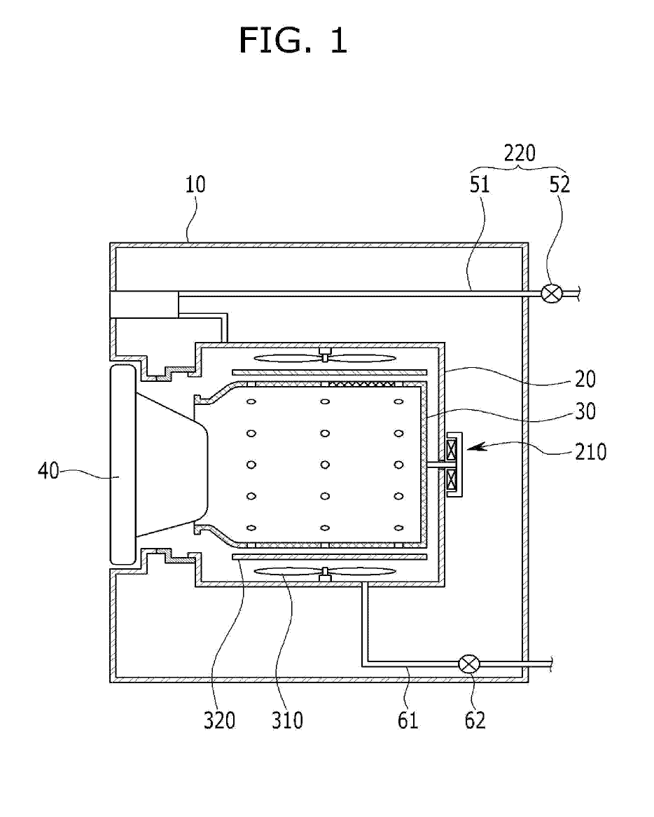

FIG. 1 is a lateral cross-sectional view illustrating an exemplary washing machine to which an apparatus and a method of controlling a washing machine of the present disclosure are applied. A structure of the washing machine to which the apparatus and the method of controlling the washing machine are applied will be described in detail with reference to FIG. 1.

As illustrated in FIG. 1, the washing machine includes a cabinet 10 forming an external structure, form and/or appearance of the washing machine, a tub 20 inside the cabinet 10, a rotatable drum 30 inside the tub 20 that accommodates clothes or other laundry, and a door 40 for opening and closing an opening of the drum 30 and insert the laundry into the drum 30 or remove the washed clothes or laundry from the drum 30.

The tub 20 receives water for washing through a water supply path 51 connected to a water supply source outside the washing machine. A water supply valve 52 may be in the water supply path 51. Here, the water supply path 51 and the water supply valve 52 form a water supply device 220.

After the completion of the washing process, water in the tub 20 is discharged to the outside of the washing machine through a drainage path 61 at or in a lower section of the tub 20. A drainage valve 62 may be in the drainage path 61.

The drum 30 holds washed clothes or laundry, and rotates in the tub 20 when receiving a rotating force from a driver 210 on or near an external rear surface of the tub 20.

A fan 310 and a heater 320 are between the tub 20 and the drum 30, and serve to dry the washed clothes when a drying process is performed after washing, rinsing, and spin-drying the laundry.

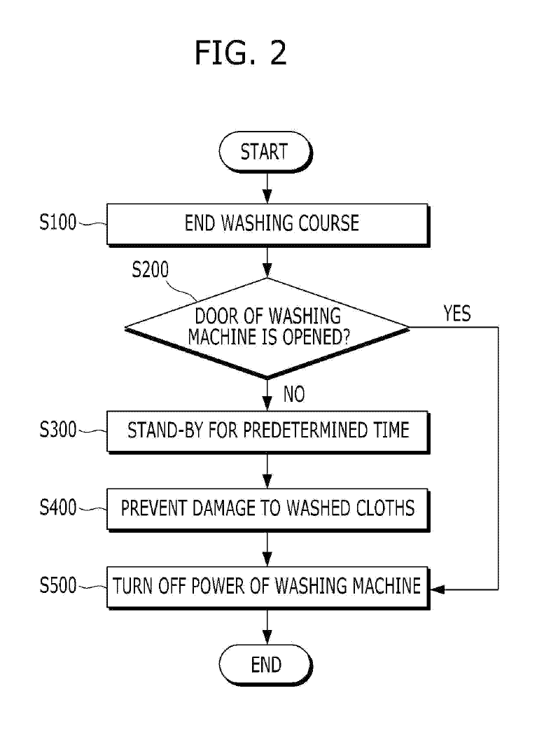

FIG. 2 is a flowchart illustrating an exemplary method of controlling the washing machine of the present disclosure. The exemplary method of controlling the washing machine will be described in detail with reference to FIG. 2.

As illustrated in FIG. 2, when a user first inserts laundry into the washing machine and selects a washing process, cycle, or course, a washing process, cycle, or course is performed according to the selection of the user. When a time of the selected washing process, cycle or course elapses, all of the washing processes, cycles or courses of the washing machine, such as washing, rinsing, spin-drying, and drying, end (S100).

After washing ends (S100), the washing machine generates a sound or alarm notifying the user that the washing process has ended. Subsequently, the opening of the door 40 of the washing machine is detected (S200).

According to the present disclosure, when the user fails to hear the ending sound (e.g., alarm), forgets to remove the washed clothes, or the user leaves the premises, the power of the washing machine remains on and does not turn off until the door 40 is opened to remove the laundry, preventing damage to and/or unpleasant smells in the washed clothes left inside the washing machine. The power of the washing machine is turned off by sensing the opening of the door 40 in a door sensing step S200 (S500).

When the door 40 is not open in the door sensing step S200, the washing machine stands-by for a predetermined time t in which the power is not turned off (S300). When the predetermined time t elapses in the stand-by step S300, damage to the washed clothes inside the drum 30 is prevented (S400).

The stand-by step S300 and the washed clothes protecting step S400 are repeatedly performed in one or more cycles for the predetermined time t. When the open door 40 is sensed during the stand-by step S300 and the washed clothes protecting step S400, power to the washing machine is turned off.

According to the present disclosure, the continuously repeated performance of the stand-by step S300 and the washed clothes protecting step S400 until the door 40 is opened by the user may cause a problem, such as, excessive power consumption. Thus, the number of times that the stand-by step S300 and the washed clothes protecting step S400 may be performed may be set by the user. This number may be 1 or more (e.g., 2, 3, 5, or any value that the user selects and/or desires). The predetermined stand-by time may also be set by the user (e.g., 5 minutes or more, 30 minutes or more, 1 hour or more, 2 hours or more, etc.). In addition, the operations performed during the clothes protecting step S400 may be selected by the user (e.g., rotation only, drying only, rinsing and drying, etc.). When the predetermined number of times for performing the stand-by and clothes protecting steps S300-S400 set by the user have ended, power to the washing machine is turned off (S500).

Hereinafter, various exemplary embodiments of the present disclosure will be described based on the stand-by step S300 and the washed clothes protecting step S400.

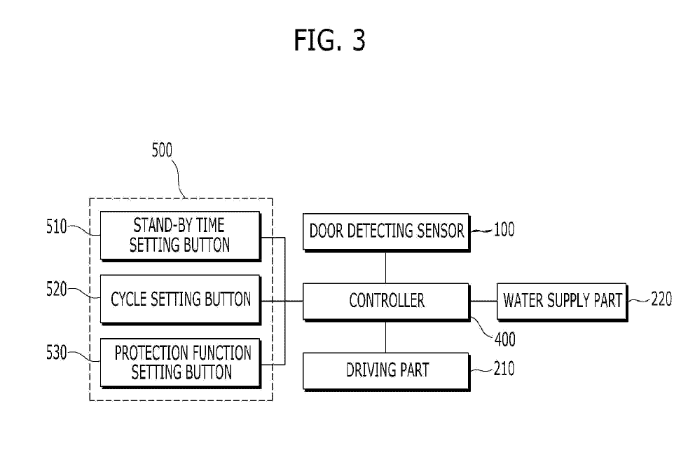

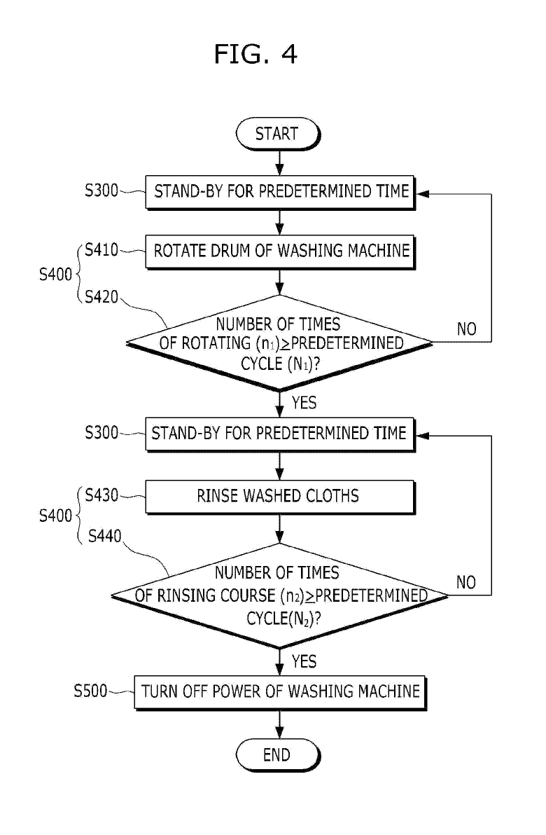

FIGS. 3 and 4 are a configuration diagram illustrating an exemplary apparatus for controlling a washing machine and a flow chart illustrating an exemplary method of controlling the washing machine according to exemplary embodiments of the present disclosure. The apparatus and the method of controlling the washing machine will be described in detail with reference to FIGS. 3 and 4.

The apparatus for controlling the washing machine includes a door detecting sensor 100, a driver 210, a water supply device 220, a controller 400, and a setting device (e.g., a setting selection panel or interface) 500. The setting selection panel or interface 500 may comprise a plurality of buttons, one or more dials, and/or a display configured to receive selections and/or inputs from the user and display settings to the user.

The door detecting sensor 100 detects whether the door 40 is open. The driver 210 drives the drum 30 of the washing machine. The controller 400 recognizes whether the door 40 is open from a signal from the door detecting sensor 100, and drives the driver 210.

Particularly, when all of the washing processes, cycles or courses of the washing machine, such as, washing, rinsing, spin-drying, and drying, end, the washing machine stands by for a predetermined time t in which power is not turned off (S300). When an open door 40 is not detected before the elapse of the predetermined time t in the stand-by step (S300), the controller 400 drives the driver 210 to rotate the drum 30 (S410). As a result, laundry having wrinkles and/or an unpleasant smell or odor is prevented or minimized.

The predetermined time t refers to a time before damage such as wrinkles and/or odor occur to the washed clothes that are left in the drum 30.

In the laundry protecting step S410 (e.g., rotating the drum 30), the controller 400 simultaneously drives the driver 210 and operates the fan 310 of the washing machine, thereby effectively preventing wrinkles and odor in the washed clothes.

In the laundry protecting step S410 (e.g., rotating the drum 30), the controller 400 drives the driver 210 and operates the fan 310, and simultaneously operates a heater 320 in the washing machine, thereby more effectively preventing wrinkles and odor in the washed clothes.

The water supply device 220 includes a water supply path 51 and a water supply valve 52 as illustrated in FIG. 1, to supply water to the drum 30. When the number of times n₁ of rotating of the drum 30 is equal to or larger than a predetermined number of cycles N₁ (S420), the controller 400 performs a rinsing cycle or course by supplying water to the drum 40 from the water supply device 220 (S430). For example, n₁ may be 5 or less (e.g., 5, 4, 3, 2 or 1).

When the number of times n₁ of the rotating of the drum 300 is relatively high, wrinkles or odor may occur in the washed clothes, so that the laundry protecting step S430 (e.g., supplying water to the drum 40 from the water supply device 220 and lightly or gently rinsing the washed clothes) is performed.

In the laundry protecting step S430 (e.g., performing the rinsing cycle), when the number of times n₂ that the rinsing course or cycle is performed is equal to or larger than a predetermined cycle N₂ (S440), the controller 400 turns off the power of the washing machine (S500). For example, n₂ may be 5 or less (e.g., 5, 4, 3, 2 or 1).

As described above, when the number of times of the rinsing course or cycle is relatively high, the washed clothes may be damaged. As a result, the rinsing course may not be performed more than a predetermined number of times, and the power of the washing machine is turned off.

A setting device 500 includes a stand-by time setting button 510, a cycle setting button 520, and a protection function setting button 530. In addition, the setting device 500 may set the predetermined time t and the predetermined cycle numbers N₁ and N₂ after the end of the washing process.

For example, when the predetermined time t is set to 10 minutes using the stand-by time setting button 510, and an open door 40 is not detected for 10 minutes after the end of the washing process, rotating the drum 30 is rotated S410, or the rinsing cycle S430 is performed at intervals of 10 minutes, thereby protecting the washed clothes.

When the predetermined cycles N₁ and N₂ are set to 5 times, rotating the drum 30 S410 or rinsing course S430 is performed 5 times, and then each subsequent step may be performed. The predetermined cycle numbers N₁ and N₂ are not limited thereto, and may be set differently, and t for each of the rotation and rinsing cycles may be set at various times, independent from each other.

Whether to operate a washed clothes protection function by rotating of the drum 30 S410 or a rinsing cycle or course S430 may also be set through the protection function setting button 530.

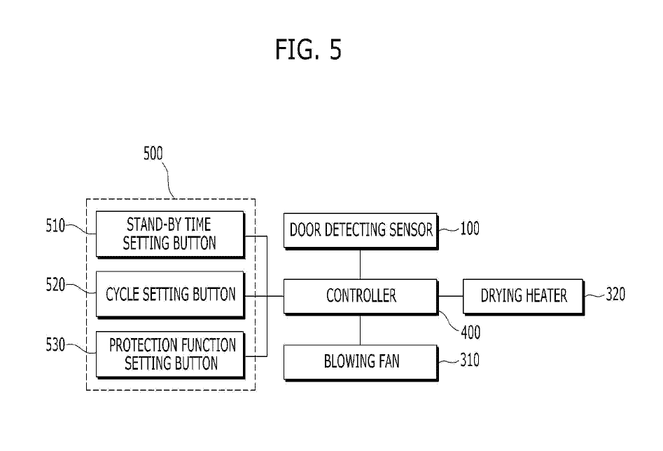

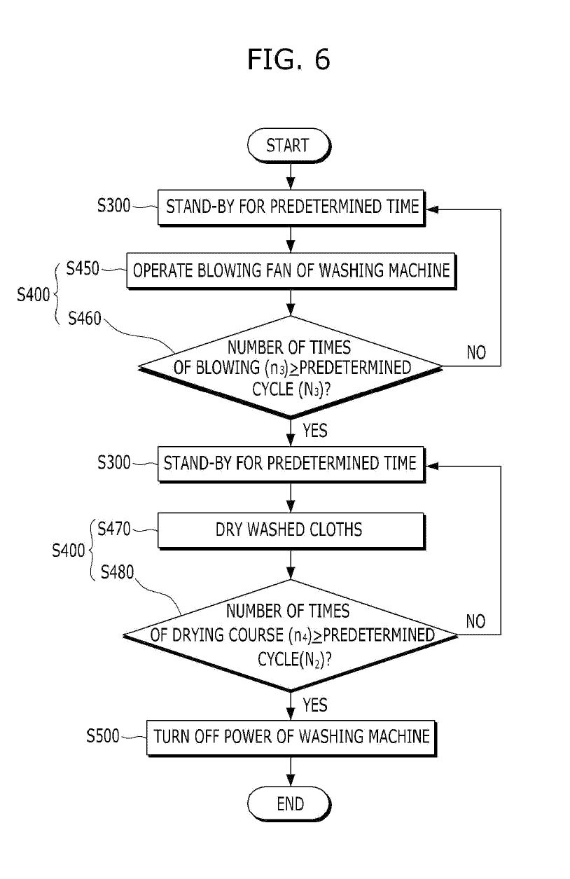

FIGS. 5 and 6 are a configuration diagram illustrating an exemplary apparatus for controlling a washing machine and a flow chart illustrating an exemplary method of controlling the washing machine according to other exemplary embodiments of the present disclosure. The exemplary apparatus and the exemplary method of controlling the washing machine will be described in detail with reference to FIGS. 5 and 6.

The apparatus for controlling the washing machine includes a door detecting sensor 100, a fan 310, a heater 320, a controller 400, and a setting device 500.

The door detecting sensor 100 detects opening of a door 40. At least one fan 310 configured to blow air through the drum 30 is adjacent to an outer periphery of the drum 30 of the washing machine, and the controller 400 recognizes whether the door 40 is open from a signal from the door detecting sensor 100, and operates the fan 310.

Particularly, when all of the washing processes, cycles or courses of the washing machine, such as washing, rinsing, spin-drying, and drying end, the washing machine stands by for a predetermined time t in which the power is not turned off S300. When an open door 40 is not detected before the elapse of the predetermined time t in the stand-by state S300, the controller 400 operates the fan 310. As a result, wrinkles and/or unpleasant smell or odor in the laundry is prevented or minimized (S450).

The predetermined time t refers to a time before damage such as wrinkles and/or odor occur to the washed clothes that are left in the drum 30.

In the laundry protecting step S450 (e.g., operating the fan 310), the controller 400 simultaneously operates the fan 310 and drives the driver 210 to rotate the drum 30, thereby effectively preventing wrinkles and odor in the washed clothes.

At least one heater 320 configured to heat the air blown into the drum 30 to dry the clothes is adjacent to the outer periphery of the drum 30 between the tub 20 and the drum 30, illustrated in FIG. 1. When the number of times n₃ of drying by the fan 310 is equal to or larger than a predetermined number of cycles N₃ (S460), the controller 400 performs a drying cycle or course using the heater 320 (S470). For example, N₃ may be 5 or less (e.g., 5, 4, 3, 2 or 1).

When the number of times that air is blown by the fan 310 is relatively high, wrinkles and/or odors may occur in the washed clothes, and the laundry protecting step S470 (e.g., performing the drying cycle using the heater 320) is performed.

In the laundry protecting step S470 (e.g., drying course using the heater 320), the controller 400 simultaneously performs the drying course and drives the driver 210 to rotate the drum 30, thereby more effectively preventing wrinkles and odor in the washed clothes.

In the laundry protecting step S470 (e.g., performing the drying cycle or course), when the number of times n₄ of the drying course is equal to or larger than a predetermined number of cycles N₄ (S480), the controller 400 turns off the power of the washing machine (S500). For example, n₄ may be 5 or less (e.g., 5, 4, 3, 2 or 1).

As described above, when the number of times of the drying course is relatively high, the washed clothes may be damaged, so that the drying course is not performed more than by a predetermined number of times, and the power of the washing machine is turned off.

The setting device (e.g., panel or interface) 500 includes a stand-by time setting button 510, a cycle setting button 520, and a protection function setting button 530. In addition, the setting device 500 may set the predetermined time t and the predetermined cycle numbers N₃ and N₄ after the end of the washing process.

For example, when the predetermined time t is set to 10 minutes using the stand-by time setting button 510, and an open door 40 is not detected for 10 minutes after the end of the washing process, operating the fan 310 occurs S450, or the drying course S470 is performed at intervals of 10 minutes, thereby protecting the washed clothes.

When the predetermined cycles N₃ and N₄ are set to 5 times, operating the fan 310 S450 or performing the drying course S470 is performed up to 5 times, and then each subsequent step may be performed. The predetermined cycle numbers N₃ and N₄ are not limited thereto and may be set differently, and t for each of the rotation and rinsing cycles may be set at various times, independent from each other.

Whether to operate a washed clothes protection function of the present disclosure, such as operating the fan 310 at step S450 or drying the laundry at S470, may be set through the protection function setting button 530.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus for controlling a washing machine, comprising:
a door detecting sensor configured to detect an open door of the washing machine;
a driver configured to drive a drum of the washing machine; and
a controller configured to recognize or determine whether the door is open from the door detecting sensor, and drive the driver to rotate the drum when the door is not open for a predetermined time after an end of a washing process of the washing machine.

2. The apparatus of claim 1, wherein the controller is configured to simultaneously drive the driver and operate a fan.

3. The apparatus of claim 2, wherein the controller is configured to further operate a heater.

4. The apparatus of claim 1, further comprising:
a water supply device configured to supply water to the drum, wherein when the number of times of rotating the drum is equal to or larger than a predetermined cycle, the controller supplies water to the drum through the water supply device, and performs a rinsing course or cycle.

5. The apparatus of claim 4, wherein when the number of times of the rinsing course or cycle is equal to or larger than a predetermined cycle, the controller turns off power of the washing machine.

6. The apparatus of claim 5, further comprising a setting device configured to set (i) the predetermined time after the end of the washing process and (ii) the predetermined cycle(s).

7. An apparatus for controlling a washing machine, comprising:
a door detecting sensor configured to detect an open door of the washing machine;
at least one fan at an outer periphery of a drum of the washing machine; and
a controller configured to recognize or determine whether the door is open from the door detecting sensor, and drive the fan when the door is not open for a predetermined time after an end of the washing process.

8. The apparatus of claim 7, wherein the controller is configured to simultaneously operate the fan and drives the driver to rotate the drum.

9. The apparatus of claim 7, further comprising:
at least one heater at an outer periphery of the drum,
wherein when the number of times that air is blown by the fan is equal to or larger than a predetermined number, the controller performs a drying course or cycle using the heater.

10. The apparatus of claim 9, wherein the controller is configured to simultaneously perform the drying course or cycle and drive the driver to rotate the drum.

11. The apparatus of claim 9, wherein when the number of times of the drying course or cycle is equal to or larger than a predetermined number, the controller turns off power to the washing machine.

12. The apparatus of claim 11, further comprising a setting device configured to set (i) the predetermined time after the end of the washing process and (ii) the predetermined cycle(s).

13. A method of controlling a washing machine, comprising:
ending a washing process or course of the washing machine;
detecting an open door after the washing process or course ends;
standing-by or waiting for a predetermined time while the door is not open; and
protecting washed clothes in a drum of the washing machine.

14. The method of claim 13, further comprising repeating standing-by and preventing damage to the washed clothes.

15. The method of claim 13, wherein detecting the open door while standing by and protecting the washed clothes comprises turning off the power of the washing machine.

16. The method of claim 13, wherein protecting the washed clothes comprises rotating the drum.

17. The method of claim 16, wherein protecting the washed clothes comprises simultaneously rotating the drum and blowing air through or into the drum.

18. The method of claim 17, wherein protecting the washed clothes further comprises heating the air being blown into the drum.

19. The method of claim 16, wherein protecting the washed clothes comprises rinsing the washed clothes when the number of times that the drum is rotated is equal to or larger than a predetermined number.

20. The method of claim 19, wherein when the number of times that the drum is rotated is equal to or larger than a predetermined number, power of the washing machine is turned off.

21. The method of claim 13, wherein protecting the washed clothes comprises blowing air into the drum.

22. The method of claim 21, wherein protecting the washed clothes further comprises rotating the drum.

23. The method of claim 21, wherein protecting the washed clothes further comprises heating the air when the number of times that air is blown is equal to or larger than a predetermined number.

24. The method of claim 23, wherein protecting the washed clothes further comprises rotating the drum.

25. The method of claim 23, wherein when the number of times that the drum is rotated is equal to or larger than a predetermined number, power of the washing machine is turned off.
